(19) United States
(12) Patent Application Publication
(10) Pub. No.: US 2026/0225124 A1
(43) Pub. Date: Aug. 6, 2026

(54) EXTERIOR-INSTALLABLE POLY COUPLER SYSTEM WITH EXTERIOR TAB RETENTION FOR IRRIGATION SPANS

(71) Applicant: Valmont Industries, Inc., Omaha, NE (US)

(72) Inventor: Cory J. Dillon, Arlington, NE (US)

(73) Assignee: Valmont Industries, Inc., Omaha, NE (US)

(21) Appl. No.: 19/630,715

(22) Filed: Mar. 27, 2026

Related U.S. Application Data
(63) Continuation-in-part of application No. 19/367,893, filed on Oct. 24, 2025.
(60) Provisional application No. 63/716,773, filed on Nov. 6, 2024.

(51) Int. Cl. B05B 15/658; A01G 25/09; B05B 1/20

(52) U.S. Cl. CPC B05B 15/658; A01G 25/097; B05B 1/202

(57) ABSTRACT

An exterior-installable poly coupler system including a main coupler body configured for insertion into an opening formed in an irrigation span pipe from the exterior thereof. The main coupler body includes a main body head with an internal receiving opening and a central tab ring with a plurality of outwardly extending locking tabs. The locking tabs are arranged to engage corresponding locking slots formed in a keyed locking ring on the exterior surface of the irrigation span pipe. The main coupler body is interchangeable with other coupler bodies in the system and allows secure installation and retention of sprinkler components without requiring access to the interior of the irrigation span pipe.

### RELATED APPLICATIONS

The present application claims priority to and is a Continuation-In-Part of U.S. Patent Application 19/367,893 filed Oct. 24, 2025, which further claims priority to U.S. Provisional Application No. 63/716,773 filed Nov. 6, 2024.

### FIELD OF THE PRESENT INVENTION

The present invention relates generally to irrigation machines and, more particularly, to an exterior-installable poly coupler system for use in irrigation systems.

### BACKGROUND OF THE INVENTION

Modern field irrigation machines are combinations of drive systems and sprinkler systems. Common irrigation machines most often include an overhead sprinkler irrigation system consisting of several segments of pipe (usually galvanized steel or aluminum) joined together and supported by trusses, mounted on wheeled towers with sprinklers positioned along their length. These machines move in a circular pattern (if center pivot) or linearly and are fed with water from an outside source (i.e., a well or water line). The essential function of an irrigation machine is to transport water (and other applicants) from a water source to a given location.

An important connection point for distributing water through an irrigation span involves the connection of sprinkler components and nozzles to the main irrigation span. These components attach to couplers, which are attached to openings created in the top surface of the irrigation span. The current design of these couplers requires access to the interior of the span to install and maintain. To get this access requires significant mechanical know-how, and the installation process is labor-intensive and time-consuming. This complexity increases installation costs and introduces potential difficulties in ensuring proper coupling integrity, especially in long-span irrigation systems. What is needed is an improved coupler that can allow for quick nozzle installation and maintenance.

### SUMMARY OF THE DISCLOSURE

To minimize the limitations found in the prior art, and to minimize other limitations that will be apparent upon the reading of the specifications, the present invention provides an exterior-installable poly coupler system for use in irrigation systems.

According to a first preferred embodiment, the poly-coupler system of the present invention includes a main coupler body and a coupler insert that are engineered to allow installation from the exterior of the pipe.

According to a further preferred embodiment, the main coupler body of the present invention preferably includes a head with internal ratchet teeth and a lower section with tapered segments. According to a further preferred embodiment, the coupler insert of the present invention preferably may include an insert head, an insertion stem, and a flange with ratchet pawls for secure engagement.

According to a further preferred embodiment, the main coupler body of the present invention will preferably include a tapered section that will be internally threaded. Further, the main coupler body may preferably include a locating tab to ensure proper installation and prevent spinning when being installed.

In accordance with a further aspect of the invention, a main coupler body is provided, which includes one or more exterior tabs extending radially outward from the main coupler body.

In accordance with yet another aspect of the invention, the main coupler body may be interchangeable with other main coupler body configurations within the same poly coupler system, allowing the system to be adapted for different installation requirements, span pipe geometries, or field conditions without altering the coupler insert or sprinkler components.

According to a further preferred embodiment, the poly-coupler of the present invention allows for exterior installation, thereby addressing the limitations of current internal installation methods. The improved assembly of the present invention ensures secure and efficient coupling, reducing installation time and enhancing the overall performance of irrigation systems.

The exterior-installable poly coupler system of the present invention reduces installation time, eliminates the need for interior span access, improves retention and stability, and facilitates efficient installation, maintenance, and retrofit of irrigation sprinkler components.

### BRIEF DESCRIPTION OF THE DRAWINGS

FIG. 1 illustrates an exemplary self-propelled irrigation system that may be used with implementations of the present invention.

FIG. 2 is an illustration of an exemplary coupler assembly of the present invention.

FIG. 3 is a perspective view of an exemplary main coupler body including a main body head and a lower section in accordance with a first preferred embodiment of the present invention.

FIG. 4 is a perspective view of an exemplary coupler insert including an insert head and insert stem in accordance with a first preferred embodiment of the present invention.

FIG. 5A illustrates the pre-insertion position of a coupler insert in accordance with a first preferred embodiment of the present invention.

FIG. 5B illustrates a post-insertion position of a coupler insert in accordance with a first preferred embodiment of the present invention.

FIG. 6 is a first perspective view of a pair of coupler assemblies in a first pre-insertion position and a post-insertion position.

FIG. 7 is a top-down view of an inserted coupler insert.

FIG. 8 is an enlarged view of the section indicated in FIG. 7.

FIG. 9 is a perspective view of an exemplary coupler assembly of the present invention inserted within an irrigation span in accordance with a first preferred embodiment of the present invention.

FIG. 10 is a top-down view of an exemplary opening formed within an irrigation span for insertion of the exemplary coupler assembly of the present invention.

FIG. 11 is a perspective view of a main coupler body including a tabbed ring in accordance with a further embodiment of the present invention.

FIG. 12 is a top-down view of the main coupler body of FIG. 11.

FIG. 13 is a perspective view of the main coupler body of FIG. 11, positioned for insertion into a keyed locking ring attached to a pipe span.

FIG. 14 is a perspective view of the main coupler body of FIG. 11, inserted into a keyed locking ring attached to a pipe span.

FIG. 15 is a top-down view of the main coupler body of FIG. 11, inserted into a keyed locking ring attached to a pipe span.

FIG. 16 is a top-down view of the main coupler body of FIG. 11, inserted into the keyed locking ring of the present invention and rotated to lock the main coupler body within the keyed locking ring.

FIG. 17 is a cross-sectional view of the main coupler body of FIG. 11, inserted into the keyed locking ring of the present invention and rotated to lock the main coupler body within the keyed locking ring.

FIG. 18 is a cross-sectional view of the main coupler body of FIG. 11 inserted into the keyed locking ring of the present invention, in which the locking tabs include a locking ridge/pin.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art. The descriptions, embodiments, and figures used are not to be taken as limiting the scope of the claims.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Moreover, the terms “embodiments of the invention”, “embodiments” or “invention” do not require that all embodiments of the invention include the discussed feature, advantage or mode of operation, nor that it does not incorporate aspects of the prior art which are sub-optimal or disadvantageous.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Additionally, any examples or illustrations given herein are not to be regarded in any way as restrictions on, limits to, or express definitions of, any term or terms with which they are utilized. Instead, these examples or illustrations are to be regarded as illustrative only.

As used herein, the singular forms “a”, “an” and “the” are intended to include the plural forms as well, unless the context clearly indicates otherwise. Additionally, the word “may” is used in a permissive sense (i.e., meaning “having the potential to’), rather than the mandatory sense (i.e., meaning “must”). Further, it should also be understood that throughout this disclosure, unless logically required to be otherwise, where a process or method is shown or described, the steps of the method may be performed in any order (i.e., repetitively, iteratively, or simultaneously) and selected steps may be omitted. It will be further understood that the terms “comprises,” “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

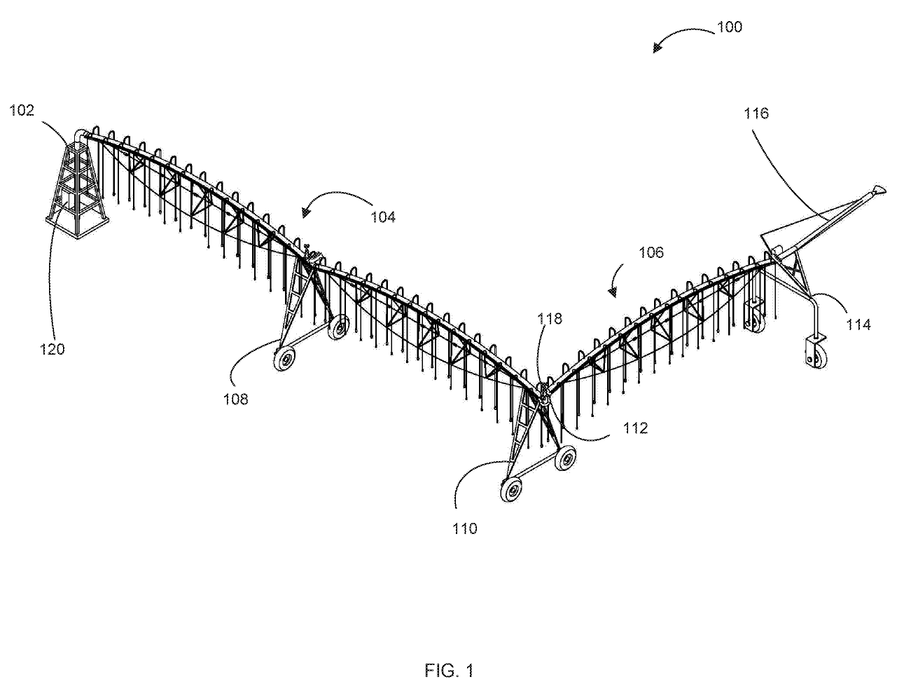

FIG. 1 illustrates an exemplary self-propelled irrigation system 100 which may be used with example implementations of the present invention. As should be understood, the irrigation system 100 disclosed in FIG. 1 is an exemplary irrigation system onto which the features of the present invention may be integrated. Accordingly, FIG. 1 is intended to be illustrative and any of a variety of systems (i.e., fixed systems as well as linear, center pivot and corner systems) may be used with the present invention without limitation.

With reference now to FIG. 1, an exemplary irrigation machine 100 of the present invention preferably may include a center pivot structure 102, a main span 104, and supporting drive towers 108, 110. The exemplary irrigation machine 100 may also include a corner span 106 attached at a connection point 112. The corner span 106 may be supported and moved by a steerable drive unit 114. The corner span 106 may include a boom 116 and an end gun (not shown) and/or other sprayers. Additionally, a position sensor 118 may provide positional and angular orientation data for the system. A central control panel 120 may also be provided and may enclose on-board computer systems for monitoring and controlling the operations of the irrigation machine. The control panel 120 may also be linked to a transceiver for transmitting and receiving data between system elements, device/internet clouds, remote servers and the like.

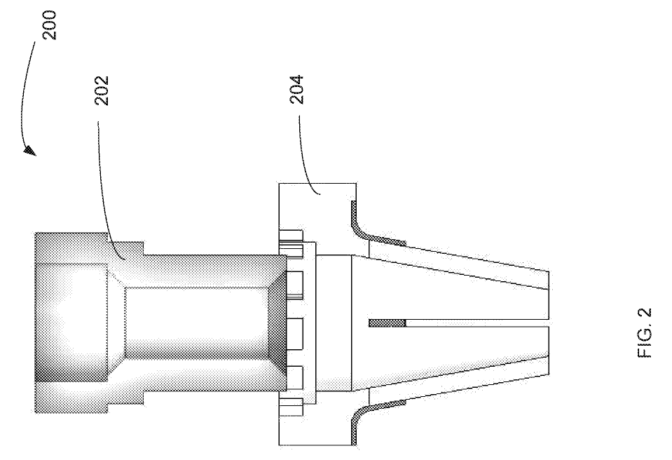

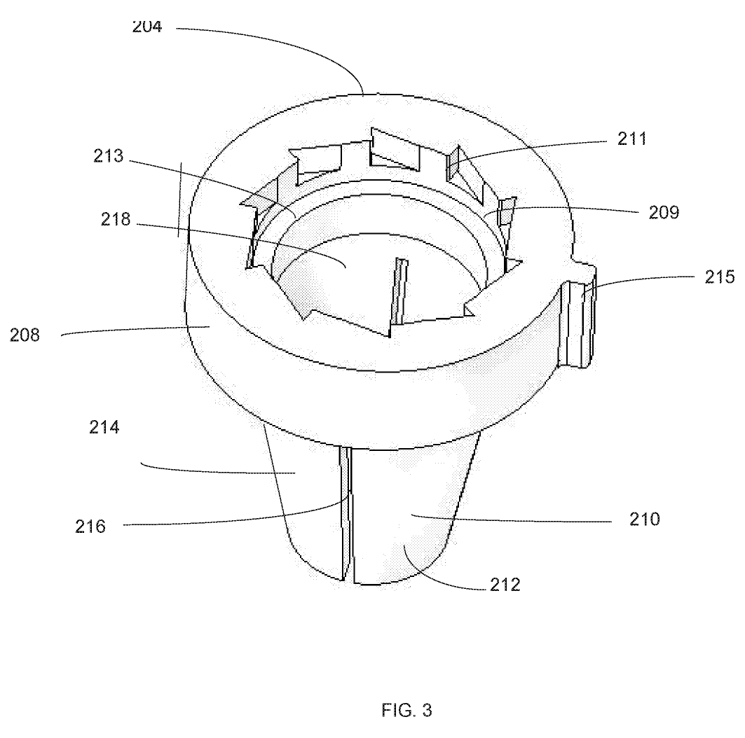

As shown in FIG. 2, coupler assembly 200 of the present invention preferably includes a main coupler body 204 and a coupler insert 202. As shown in FIG. 3, the main coupler body 204 preferably includes a main body head 208 and a lower section 210. The main body head 208 is preferably a circular body forming an internal receiving hole 218. The upper internal surface 209 of the main body head 208 preferably includes internal ratchet teeth 211 which preferably ring the upper internal surface 209 of the main body head 208. The lower internal surface 213 of the main body head 208 is preferably internally threaded. The main body head 208 preferably further includes a locating tab 215.

The lower section 210 of the main coupler body 204 preferably includes one or more tapered segments 212, 214. These segments are preferably interleaved with one or more reliefs 216 to allow for the expansion of the lower section 210 when the coupler insert 202 is installed, as discussed further below.

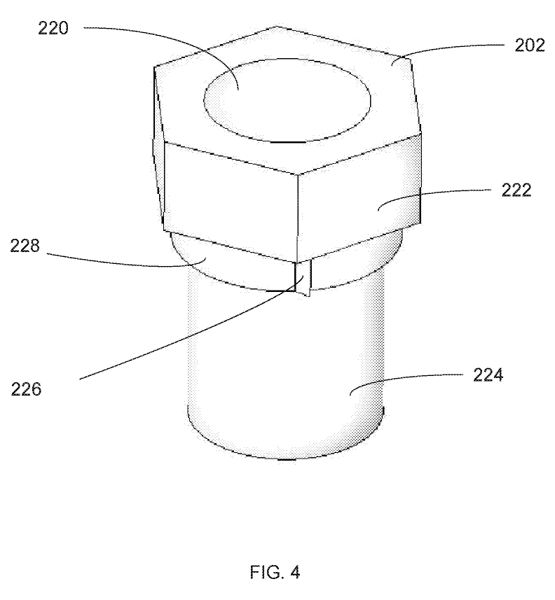

Referring now to FIG. 4, the coupler insert 202 of the present invention preferably may include an insert head 222 and an insert stem 224. Preferably, the coupler insert 202 further includes an insert flange 228 between the insert head 222 and the insert stem 224. According to a preferred embodiment, the insert flange 228 is preferably formed with one or more ratchet pawls 226 extending out from the flange 228. The insert head 222 preferably includes a central pipe insert cavity 220 which preferably may be an internally threaded hole that is formed and sized to receive a drop-down sprinkler base or the like. According to a further preferred embodiment, the insert stem 224 is preferably externally threaded so that it may insert and screw into the lower internal surface 213 of the main body head 208.

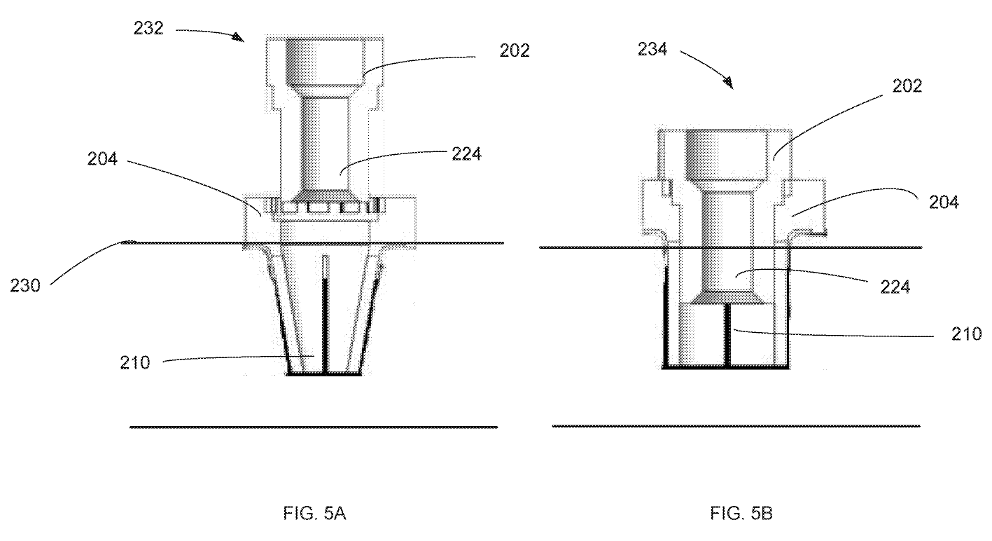

Referring now to FIGS. 5A and 5B, the insertion of the coupler insert 202 into the main coupler body 204 shall now be further discussed. FIG. 5A illustrates a first pre-insertion positioning 232 of the coupler insert 202 with the main coupler body 204 already inserted within an irrigation span 230.

In FIG. 5B, the coupler insert 202 is shown in a second position 234 where the coupler insert 202 has been screwed into the main coupler body 204 such that the insert stem 224 of the coupler insert 202 is pushed down into the lower section 210 of the main coupler body 204.

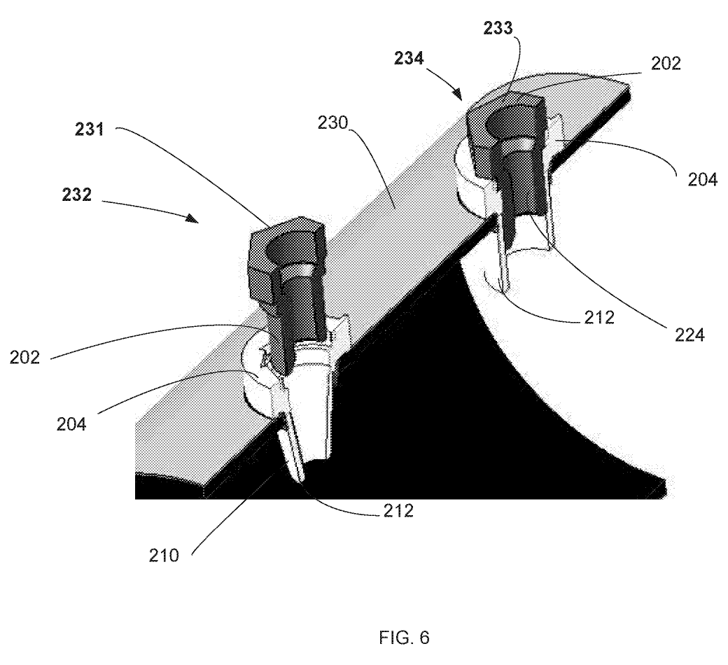

Referring now to FIG. 6, a first perspective view of a pair of coupler assemblies 231, 233 are shown respectively in a first pre-insertion position 232 and a post-insertion position 234. As shown, in the first pre-insertion position 232, the lower section 210 of the main coupler body 204 includes tapered lower segments 210, 212. In the post-insertion position 234, the insert stem 224 is screwed into the main coupler body 204 and the segments 212, 214 of the lower section 210 are pushed outward.

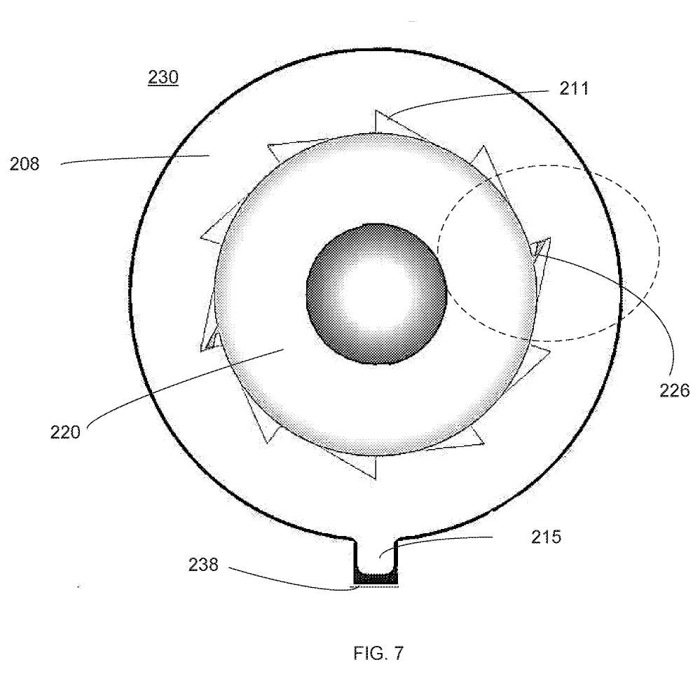

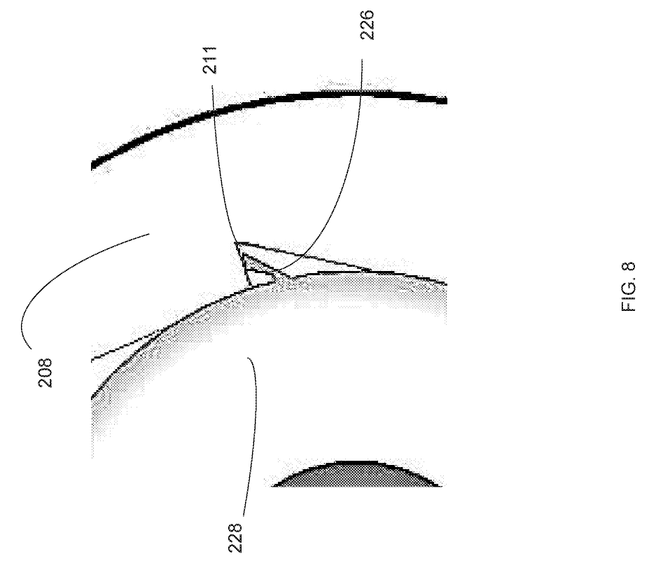

As discussed above, the coupler insert 202 preferably includes an externally threaded coupler stem 224 and an insert flange 228, which preferably includes one or more ratchet pawls 226. Referring now to FIG. 7, a top-down view of a coupler insert 202 is provided. An enlarged view of the section indicated in FIG. 7 is provided in FIG. 8. As shown, the coupler insert 202 is inserted within the coupler main body head 208. As further shown, in this position, each ratchet pawl 226 is preferably located to engage one of the ratchet teeth 211 formed in the coupler main body head 208. As further shown, the locating tab 215 of the coupler main body head 208 preferably is locked into place within a locating keyhole 238. In this way, the coupler insert 202 is secured within the coupler main body head 208 to prevent movement of an inserted pipe (not shown) when installed in an irrigation span.

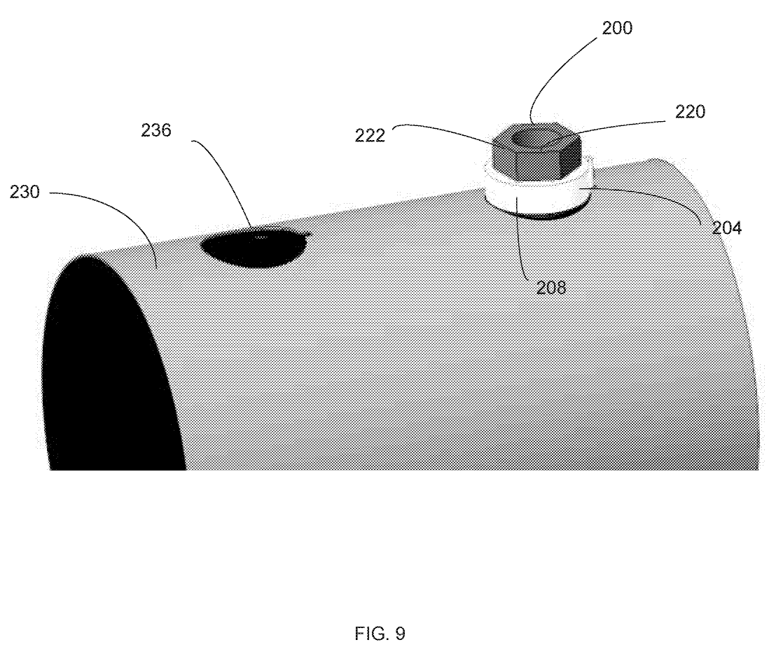

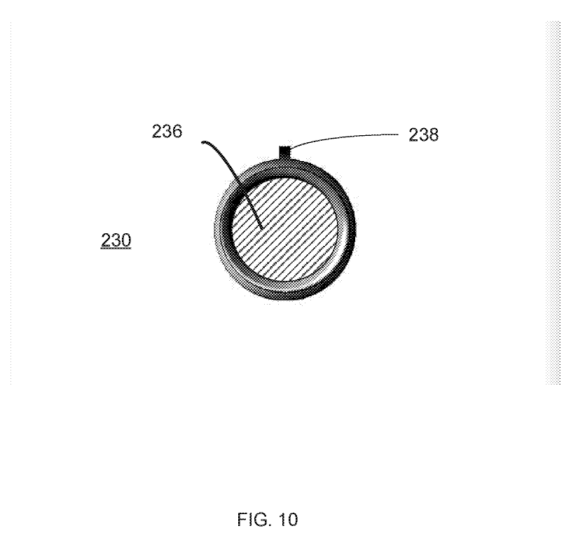

FIG. 9 is a perspective view of an exemplary coupler assembly 200 of the present invention inserted within an irrigation span 230 in accordance with a first preferred embodiment of the present invention. As shown, the coupler insert 202 is fully inserted within the coupler main body 204 so that only the insert head 222 and the coupler main body head 208 are above the span pipe 230 surface. In this position, the coupler assembly 200 is secured and ready for the insertion of a sprayer (not shown) within the insert head 222. As shown in FIG. 9, one or more insertion holes 236 are preferably spaced apart as needed on a given length of span pipe 230. As shown in FIG. 9 and FIG. 10, the insertion holes 236 preferably each may include a locating keyhole 238 to receive the locking tab 215 of an inserted coupler assembly 200.

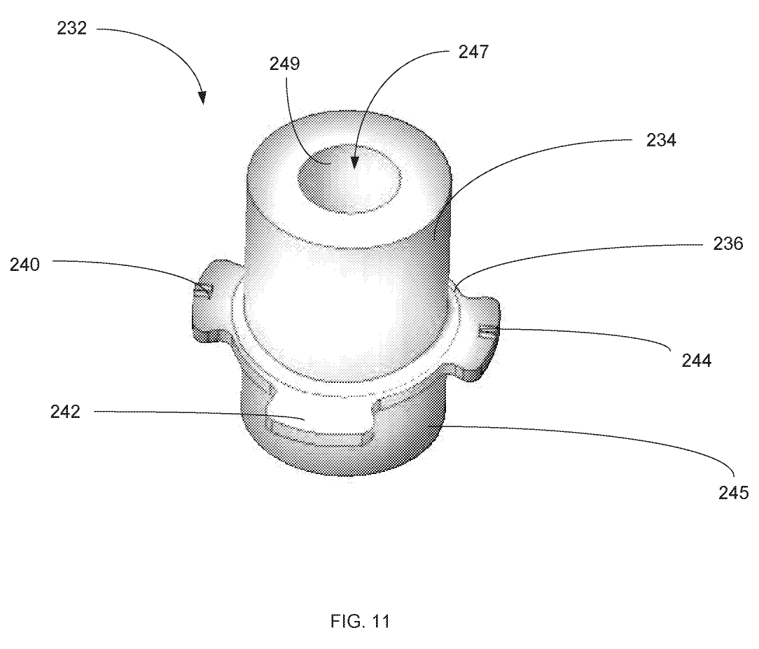

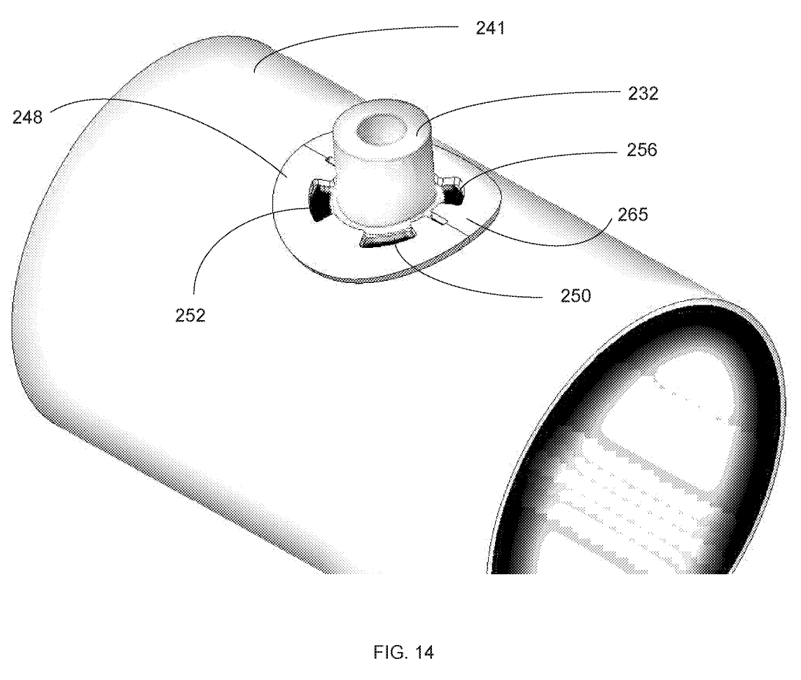

Referring now to FIGS. 11-18, a first alternative preferred embodiment of the present invention shall now be discussed. As shown, the first alternative embodiment includes a poly coupler system having a main coupler body 232 configured to engage an exterior surface of an irrigation span pipe via an integrated keyed locking ring 248. The main coupler body 232 may be used interchangeably with the previously described main coupler body and may include one or more features of any main coupler body discussed herein.

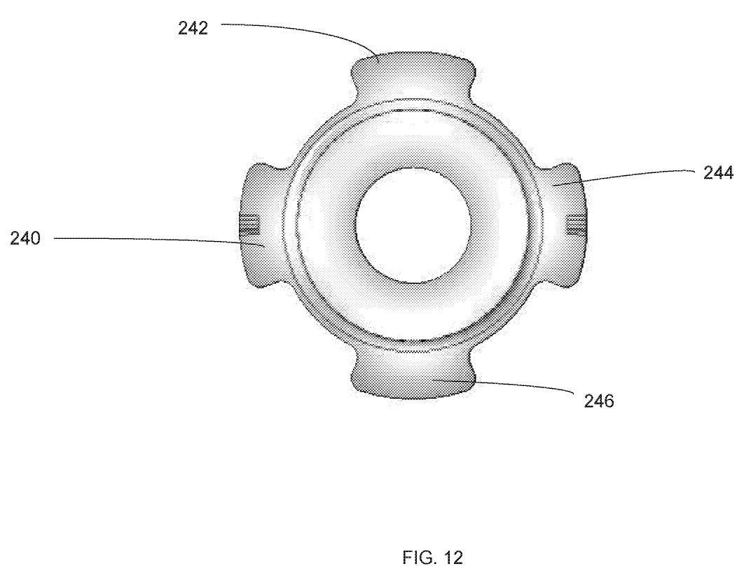

Referring first to FIGS. 11-12, the main coupler body 232 includes a central tab ring 236. The central tab ring 236, preferably, includes one or more outwardly extending locking tabs 240, 242, 244, 246, positioned around the central tab ring 236. The coupler 232 preferably further includes a lower insert section 245 and a main body head 234. The lower insert section 245 may be substantially identical to the lower section 210 of the coupler inserts 202 discussed above. For example, the lower insert section 245 may include tapered segments separated by reliefs to permit controlled radial expansion within the irrigation span pipe.

The main body head 234 preferably defines an internal receiving opening 247 having an internal surface 249. The internal surface 249 may include internal threads and/or internal ratchet teeth configured to engage a coupler insert or sprinkler attachments as discussed above. The main body head 234 may further include external threads for engaging an internally threaded irrigation component.

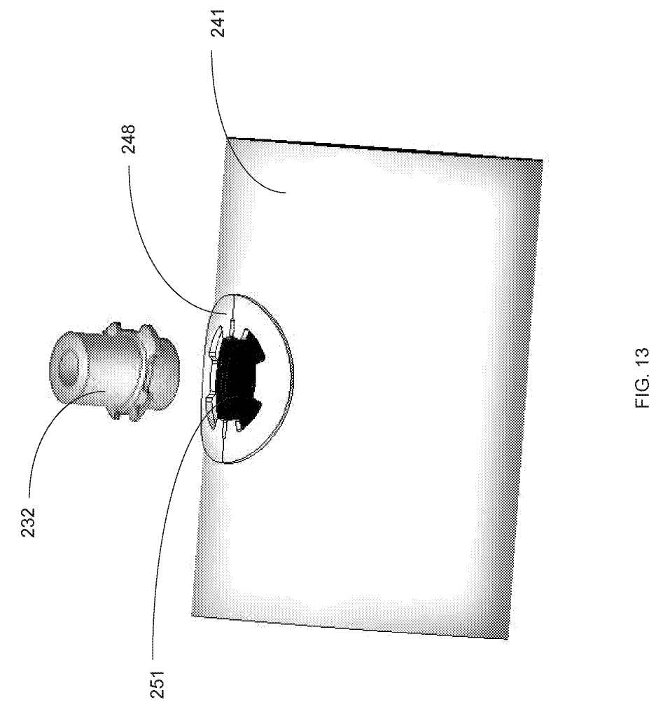

Referring now to FIGS. 13-17, in preferred embodiments, the locking tabs 240-246 are preferably arranged and sized to engage a keyed locking ring 248 formed within the exterior surface of an irrigation span pipe 241 when the main coupler body 232 is inserted through an opening 251 in the span pipe 241. According to a first preferred embodiment, the locking tabs 240-246 may preferably be circumferentially spaced and may be rigid or resilient. In certain embodiments, the additional locking tabs may be sized to overlie the pipe surface adjacent the opening, thereby preventing axial pull-through of the coupler body and resisting rotational movement during installation of the coupler insert. In some embodiments, the irrigation span opening 251 may be substantially circular, without a keyed locking ring 248.

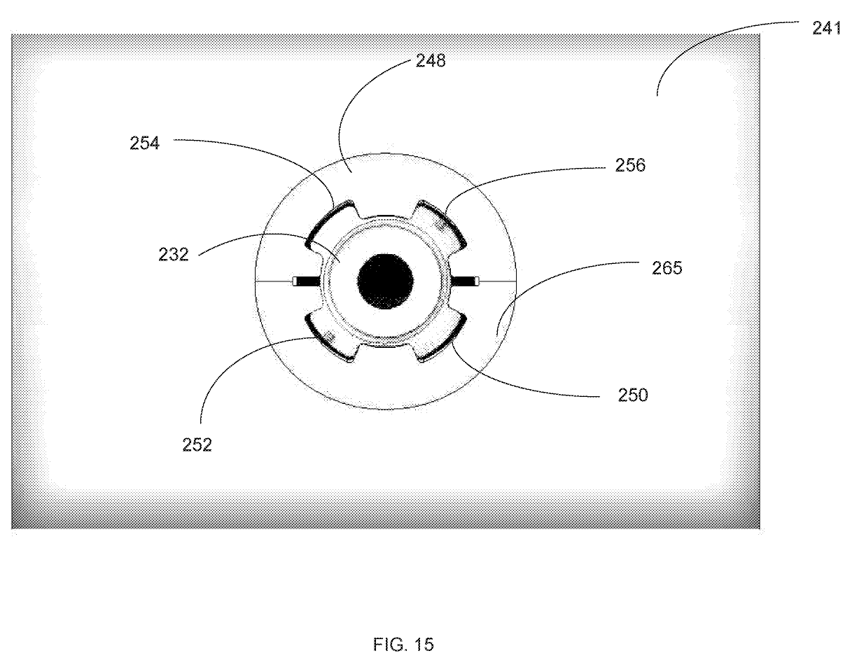

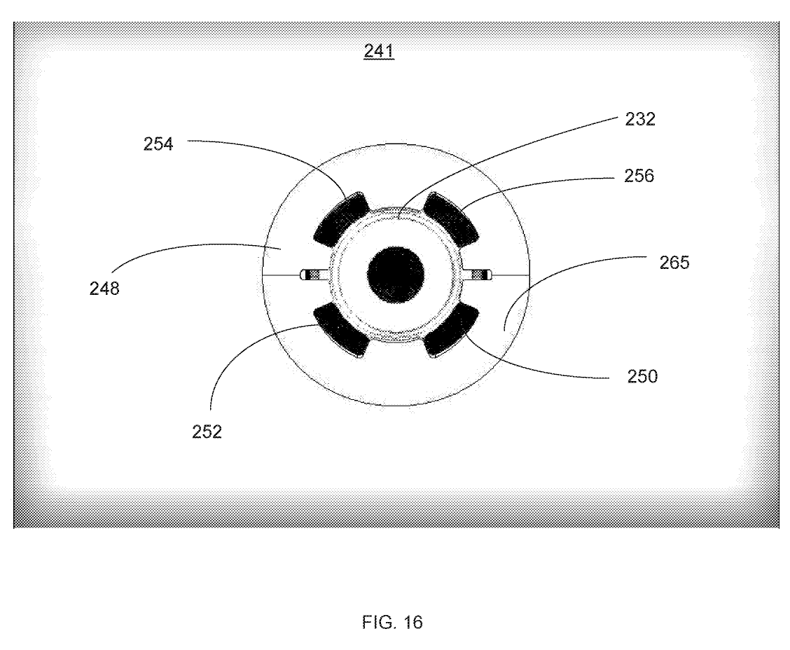

The keyed locking ring 248 preferably includes a group of locking slots 250, 252, 254, 256 which are arranged to receive the insertion tabs 240-246 when the main coupler body 232 is inserted through an opening 251 into the span pipe 241. FIG. 15 shows a top-down view of the insertion tabs 240-246 inserted into the locking slots 250, 252, 254, 256. Once inserted into the locking slots 250-256, the insertion tabs 240-246 may preferably be rotated to frictionally lock them between the span pipe surfaces and the top locking surface 265 of the keyed locking ring. FIG. 16 shows a top-down view of the insertion tabs 240-246 rotated to lock under the top locking surface 265.

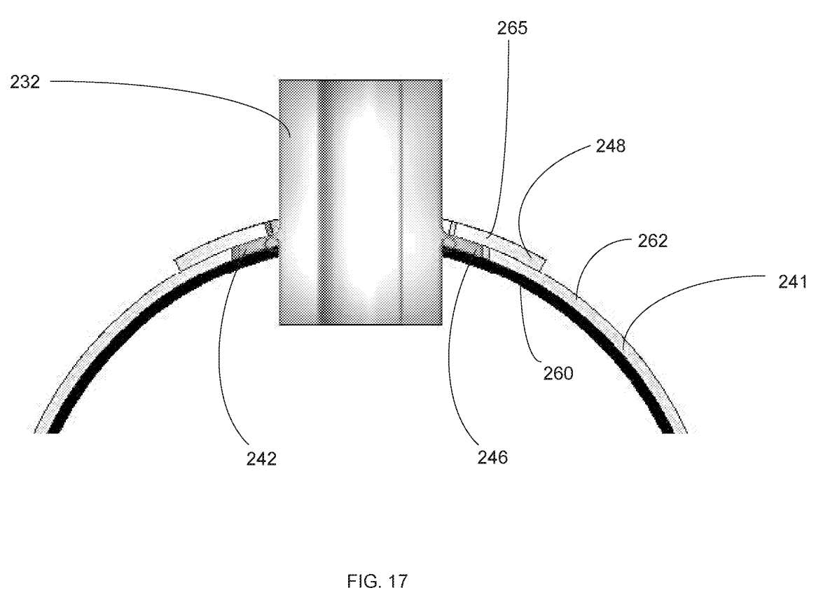

FIG. 17 shows a side cutaway view of the main coupler body 232, as shown in FIG. 16 with the tabs 242, 246 locked between the outer surface of the span (e.g., an interior lower surface 260 and an outer surface 262) and the locking ring 248. According to preferred embodiments, a compressible sealant layer may be applied to the undersurface of each insertion tab 240-246 and/or the central tab ring 236 to create a water-tight seal between each tab 240-246 and the lower surface 260 of the span. According to further alternative embodiments, an O-ring may be positioned beneath the central tab ring 236 to provide a seal between the main coupler body 232 and the lower surface 260 of the span.

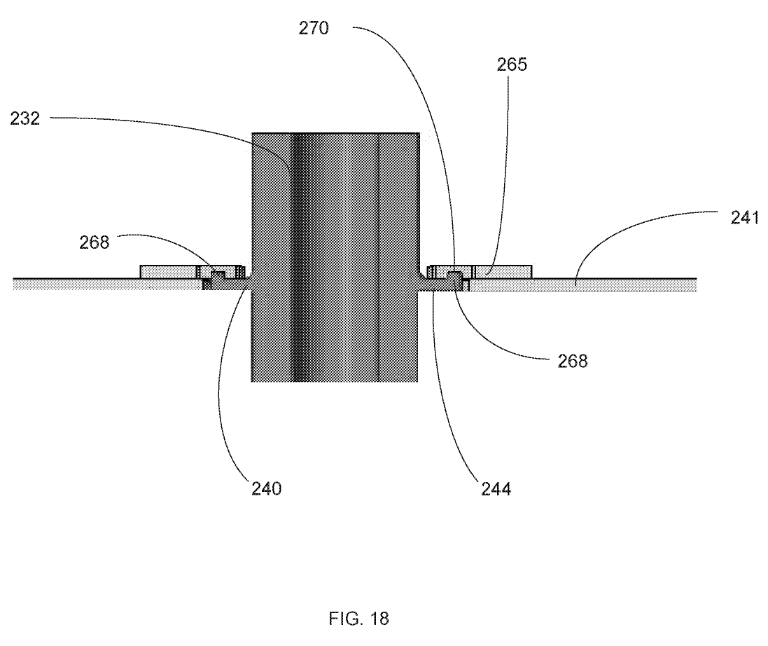

As shown in FIG. 18, each locking tab 240-246 may preferably further include a locking ridge/pin 268. The locking ridge/pins 268 may preferably be formed as projections from the surface of each locking tab 240-246. The locking ridge/pins 268 may preferably fit into one or more corresponding locking recesses 270 that may be formed within the underside of the top locking surface 265.

While the above descriptions regarding the present invention contain much specificity, these should not be construed as limitations on the scope, but rather as examples. Many other variations are possible. For example, the systems of the present invention may be used with any arrangement of irrigation spans, nozzles, sprayers and sprinklers. For example, the present invention may be used with any of a variety of impact sprinklers, spray heads and/or drop hoses. These may include any variety of nozzles, including drip irrigation nozzles, wobbler sprinklers and the like, without limitation. Accordingly, the scope of the present invention should be determined not by the embodiments illustrated, but by the appended claims and their legal equivalents.

What is claimed is:

1. An exterior-installable coupler assembly for an irrigation span pipe, comprising:
a main coupler body configured to be inserted into an opening formed in an irrigation span pipe from an exterior surface thereof, the main coupler body comprising:
a main body head;
a central tab ring; and
a lower insert section;
a plurality of tabs extending radially outward from the central tab ring;
a coupler insert configured to engage the main coupler body, the coupler insert comprising:
an insert head;
an insert stem; and
an insert flange disposed between the insert head and the insert stem; and
a keyed locking ring configured to be associated with the irrigation span pipe and defining an opening, the keyed locking ring comprising:
a plurality of locking slots configured to receive the plurality of tabs; and
a top locking surface;
wherein the plurality of tabs are configured to be inserted into the locking slots;
wherein the plurality of tabs are configured to be rotated to engage the top locking surface to secure the main coupler body to the irrigation span pipe, and
wherein the coupler insert is configured to engage the main coupler body to expand the lower insert section and secure the coupler assembly within the opening.

2. The coupler assembly of claim 1, wherein the insert stem is externally threaded and the main body head includes an internally threaded surface configured to receive the insert stem.

3. The coupler assembly of claim 1, wherein the insert flange includes one or more ratchet pawls and the main body head includes corresponding ratchet teeth configured to engage the ratchet pawls.

4. The coupler assembly of claim 1, wherein the lower insert section comprises a plurality of tapered segments separated by reliefs to permit radial expansion.

5. The coupler assembly of claim 1, wherein the plurality of tabs are circumferentially spaced around the central tab ring.

6. The coupler assembly of claim 1, wherein at least one of the tabs includes a locking projection configured to engage a corresponding recess formed in the keyed locking ring.

7. The coupler assembly of claim 1, further comprising a sealing element disposed between the central tab ring and the irrigation span pipe.

8. The coupler assembly of claim 7, wherein the sealing element comprises an elastomeric gasket or O-ring.

9. The coupler assembly of claim 1, wherein the insert head defines a pipe insert cavity configured to receive a sprinkler component.

10. The coupler assembly of claim 1, wherein the main coupler body is formed from a corrosion-resistant polymeric material.

11. A method of installing a coupler assembly in an irrigation span pipe, the method comprising:
providing an irrigation span pipe having an opening formed therein;
positioning a keyed locking ring in association with the opening;
inserting a main coupler body into the opening from an exterior surface of the irrigation span pipe such that a plurality of tabs extending from the main coupler body are received within corresponding locking slots of the keyed locking ring;
rotating the main coupler body to engage the plurality of tabs with a top locking surface of the keyed locking ring; and
inserting a coupler insert into the main coupler body to secure the main coupler body within the opening.

12. The method of claim 11, further comprising threading an insert stem of the coupler insert into an internally threaded portion of the main coupler body.

13. The method of claim 11, further comprising expanding a lower insert section of the main coupler body radially outward in response to insertion of the coupler insert.

14. The method of claim 11, further comprising engaging one or more ratchet pawls on the coupler insert with corresponding ratchet teeth formed in the main coupler body.

15. The method of claim 11, further comprising aligning a locating tab of the main coupler body with a corresponding locating feature formed in the irrigation span pipe prior to inserting the main coupler body.

16. The method of claim 11, further comprising forming a fluid-tight seal between the main coupler body and the irrigation span pipe.

17. The method of claim 16, wherein forming the fluid-tight seal includes compressing an elastomeric sealing element between the main coupler body and the irrigation span pipe.

18. The method of claim 11, further comprising installing a sprinkler component into a pipe insert cavity defined in the coupler insert after the coupler insert is secured.

19. The method of claim 11, wherein rotating the main coupler body includes rotating the main coupler body such that the plurality of tabs are frictionally captured between opposing surfaces of the irrigation span pipe and the keyed locking ring.

20. The method of claim 11, wherein the method is performed without accessing an interior of the irrigation span pipe.
